(19) United States
(12) Patent Application Publication
(10) Pub. No.: US 2024/0304842 A1
(43) Pub. Date: Sep. 12, 2024

(54) FUEL CELL SYSTEM

(71) Applicant: TOYOTA JIDOSHA KABUSHIKI KAISHA, Toyota-shi (JP)

(72) Inventors: Nobukazu MIZUNO, Nagakute-shi (JP); Seiichi TANAKA, Nagoya-shi (JP)

(73) Assignee: TOYOTA JIDOSHA KABUSHIKI KAISHA, Toyota-shi (JP)

(21) Appl. No.: 18/426,922

(22) Filed: Jan. 30, 2024

(30) Foreign Application Priority Data
Mar. 6, 2023 (JP) 2023-033724

(51) Int. Cl. H01M 8/04746; H01M 8/04082; H01M 8/0438

(52) U.S. Cl. CPC H01M 8/04753; H01M 8/04201; H01M 8/0438; H01M 2220/20

(57) ABSTRACT

An injector of a fuel cell system operates when the output amount of a fuel cell is in a first output region, and a linear solenoid valve operates when the output amount of the fuel cell is in a second output region. When the output amount of the fuel cell is in a third output region that is included in the second output region, the linear solenoid valve opens at such a degree that fuel gas and fuel off-gas necessary to secure a hydrogen amount threshold that is a smallest hydrogen amount necessary for operation of the fuel cell are capable of being introduced from an ejector into the fuel cell.

### CROSS-REFERENCE TO RELATED APPLICATION

This application claims priority to Japanese Patent Application No. 2023-033724 filed on Mar. 6, 2023, incorporated herein by reference in its entirety.

### BACKGROUND

### 1. Technical Field

The technology disclosed in the present specification relates to a fuel cell system.

### 2. Description of Related Art

A fuel cell uses fuel gas for electricity generation, and uses the fuel gas also for water drainage and scavenging in the fuel cell. When the output of the fuel cell is low, it is desirable to perform the water drainage or the like by increasing the circulation amount of fuel off-gas while reducing the use amount of fuel gas as much as possible.

It has been suggested that there be included an ejector that suctions the fuel off-gas and introduces the fuel off-gas into the fuel cell together with the fuel gas, for increasing the circulation amount of the fuel off-gas (Japanese Unexamined Patent Application Publication No. 2019-67708).

### SUMMARY

In some cases, a circulation system for the fuel gas in the fuel cell causes an injector to operate when the output amount of the fuel cell is small, and performs switching and causes a linear solenoid valve to operate when the output amount is a certain amount or more. The injector supplies the fuel gas by an intermittent flow based on the opening-closing operation of a valve by a pulse control, and the linear solenoid valve supplies the fuel gas by a steady flow proportional to the opening degree of a solenoid valve by a linear control. When the fuel gas is injected by the intermittent flow or the steady flow, the ejector suctions the fuel off-gas depending on the injection pressure, mixes the fuel off-gas with the fuel gas, and introduces the mixture into the fuel cell.

The injector and the linear solenoid valve perform different valve operations as described above. Therefore, in an output region in which the linear solenoid valve is used and in which the output amount of the fuel cell is small and the opening degree of the linear solenoid valve is low, the injection pressure of the fuel gas tends to be lower than the injection pressure when the injector operates. Accordingly, in some cases, in this region of the low opening degree, the suction amount of the fuel off-gas by the ejector decreases, and the circulation gas amount cannot be secured. When the circulation gas amount cannot be secured, the hydrogen amount necessary for the operation of the fuel cell cannot be sometimes secured, as a result. When the hydrogen amount is not sufficient, the decrease in the performance of the fuel cell is sometimes accelerated due to the oxidation of an electrode material, and the like.

The present specification provides a technology that makes it possible to secure the hydrogen amount necessary for the operation of the fuel cell in the output amount range of the fuel cell, when the fuel cell includes the circulation system for the fuel gas that uses the injector, the linear solenoid valve, and the ejector.

A fuel cell system disclosed in the present specification includes a circulation system for fuel gas in a fuel cell. The circulation system includes an injector for the fuel gas, a linear solenoid valve for the fuel gas, the linear solenoid valve being disposed in parallel with the injector, and an ejector that introduces fuel off-gas exhausted from the fuel cell, into the fuel cell, together with the fuel gas from the injector and the linear solenoid valve. The injector operates when the output amount of the fuel cell is in a first output region in which the output amount of the fuel cell is equal to or smaller than a first output amount threshold, and the linear solenoid valve operates when the output amount of the fuel cell is in a second output region in which the output amount of the fuel cell is larger than the first output amount threshold. When the output amount of the fuel cell is in a third output region that is included in the second output region and in which the output amount of the fuel cell is larger than the first output amount threshold and is equal to or smaller than a second output amount threshold, the linear solenoid valve opens at such a degree that the fuel gas and the fuel off-gas that are necessary to secure a hydrogen amount threshold are capable of being introduced from the ejector into the fuel cell, the hydrogen amount threshold being a smallest hydrogen amount necessary for operation of the fuel cell.

Thereby, even when the injector and the linear solenoid valve are used, the hydrogen amount threshold of the gas that circulates through the fuel cell is maintained, and therefore the deterioration of the fuel cell is restrained. Further, the circulation flow amount of the fuel off-gas that is introduced from the ejector into the fuel cell is secured, and therefore an appropriate scavenging and the like can pe performed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the outline of an exemplary configuration of a fuel cell system in an embodiment;

FIG. 2 shows the relation between operation regions of an injector and a linear solenoid valve and the circulation flow amount of fuel off-gas by an ejector 60 in the output range of a fuel cell in the fuel cell system in the embodiment;

FIG. 3 is a diagram showing an exemplary process of a flow amount control program for the fuel gas and fuel off-gas in the fuel cell system in the embodiment; and

FIG. 4 is a diagram showing an exemplary time chart in the fuel cell system in the embodiment.

### DETAILED DESCRIPTION OF EMBODIMENTS

A fuel cell system disclosed in the present specification includes a circulation system for fuel gas in a fuel cell. The circulation system includes an injector for the fuel gas, a linear solenoid valve (hereinafter referred to as merely an LSV) for the fuel gas, the linear solenoid valve being disposed in parallel with the injector, and an ejector that introduces fuel off-gas (hereinafter also referred to as off-gas) exhausted from the fuel cell, into the fuel cell, together with the fuel gas from the injector and the linear solenoid valve. The injector operates when the output amount of the fuel cell is in a first output region in which the output amount of the fuel cell is equal to or smaller than a first output amount threshold, and the linear solenoid valve operates when the output amount of the fuel cell is in a second output region in which the output amount of the fuel cell is larger than the first output amount threshold. When the output amount of the fuel cell is in a third output region that is included in the second output region and in which the output amount of the fuel cell is larger than the first output amount threshold and is equal to or smaller than a second output amount threshold, the linear solenoid valve opens at such a degree that the fuel gas and the fuel off-gas that are necessary to secure a hydrogen amount threshold are capable of being introduced from the ejector into the fuel cell, the hydrogen amount threshold being a smallest hydrogen amount necessary for operation of the fuel cell.

In an embodiment of the present disclosure, when the output amount of the fuel cell is in the third output region, the LSV may open at an opening degree larger than a planned opening degree that is previously specified for the output amount of the fuel cell. Thereby, the fuel gas amount and gas pressure that are supplied to the ejector are increased, and the circulation flow amount of the off-gas in the ejector is increased, so that the hydrogen amount threshold can be easily secured.

In an embodiment of the present disclosure, when the output amount of the fuel cell is in the third output region, the LSV may open such that the opening degree is larger than the planned opening degree as the output amount of the fuel cell is smaller. Thereby, although the circulation flow amount of the off-gas decreases and the securement of the hydrogen amount threshold is more difficult as the output amount is smaller in the third output region, the hydrogen amount threshold can be effectively secured, and the circulation flow amount of the off-gas can be increased.

In an embodiment of the present disclosure, the second output amount threshold may be such an output amount that the circulation flow amount of the fuel off-gas reaches a target flow amount at the planned opening degree of the linear solenoid valve for the output amount of the fuel cell. Thereby, when both of the injector and the LSV are used, the LSV can be easily controlled so as to operate while maintaining the hydrogen amount threshold from a low output region to a high output region.

In an embodiment of the present disclosure, after the output amount of the fuel cell exceeds the third output region, the LSV may open at the planned opening degree for the output amount of the fuel cell. Since the LSV opens at the planned opening degree, it is possible to secure the hydrogen amount and the off-gas circulation flow amount that are suitable for the output amount of the fuel cell.

In the present specification, regarding thresholds, words such as “equal to or larger than”, “larger than”, “equal to or smaller than”, and “smaller than” are set in the relation with numerical values. Depending on the numerical value of a threshold that is set, the expression as “equal to or larger than” or “larger than” is adopted, and similarly, the expression as “equal to or smaller than” or “smaller than” is adopted. Accordingly, one of “equal to or larger than” and “larger than” can mutually include the meaning of the other, and the same goes for “equal to or smaller than” and “smaller than”.

The circulation control of fuel gas and off-gas in the fuel cell system disclosed in the present specification will be described with reference to the drawings when appropriate.

The fuel cell system described below includes a fuel cell including a stack in which many fuel cell cells are stacked in series, a circulation system that circulates fuel gas (hydrogen), and a control device. In addition, the fuel cell system includes an oxidant gas supply system that supplies oxidant gas (air), and a cooling system that includes a coolant pump, a coolant flow passage and the like. The use purpose of the fuel cell system is not particularly limited. For example, the fuel cell system may be used as a mobile fuel cell system that is mounted on a mobile body such as a vehicle and a ship, or may be used as a stationary fuel cell system that is employed in a stationary electricity generation facility.

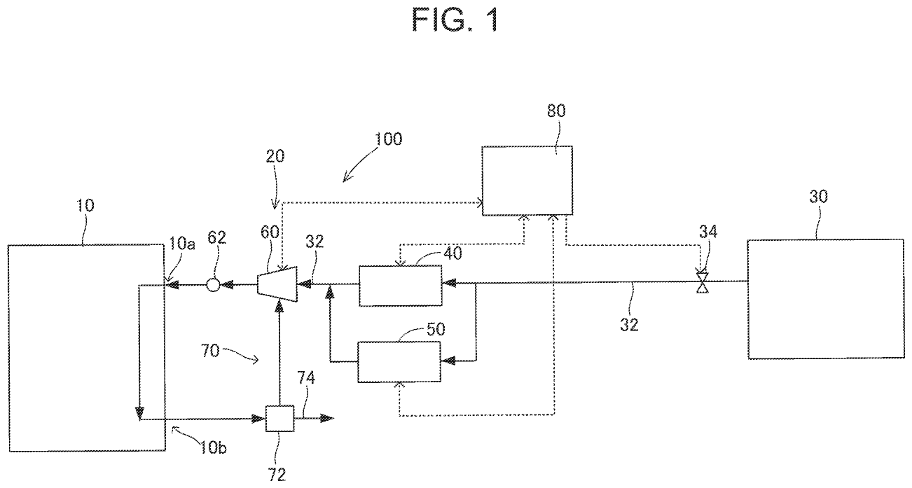

FIG. 1 shows the outline of the configuration of a fuel cell system 100 in an embodiment disclosed in the present specification. The fuel cell system 100 includes a fuel cell 10, a fuel gas circulation system 20 through which fuel gas circulates, an oxidant gas supply system (not illustrated), and a control device 80. In addition, although not illustrated, the fuel cell system 100 includes a coolant circulation system for cooling the fuel cell 10.

The fuel cell 10 is conventionally known, and is not particularly limited, and for example, a polymer electrolyte fuel cell (PEFC) may be used. The fuel cell 10 includes an unillustrated sensor for acquiring the hydrogen stoichiometric ratio of the gas that circulates in the interior of the fuel cell 10. The detection value of the sensor is sent to the control device 80, and the hydrogen stoichiometric ratio in the fuel cell 10 is calculated.

The fuel gas circulation system 20 includes an injector 40, an LSV 50, and an ejector 60, in addition to a tank 30 for the fuel gas and a supply flow passage 32 through which the fuel gas is supplied to the fuel cell 10.

The tank 30 only needs to be a storage device for hydrogen, and various known members such as a compressed hydrogen bomb, a liquid hydrogen tank, and a hydrogen absorbing alloy member can be adopted. A regulator 34 for regulating the flow amount of the fuel gas from the tank 30 and a pressure sensor (not illustrated) are provided downstream of the tank 30. The opening degree of a valve of the regulator 34 is regulated by a control signal that is sent from the control device 80 described later, and a pressure value detected in the pressure sensor is sent to the control device 80.

The injector 40 is disposed downstream of the tank 30, and injects and supplies the fuel gas to the ejector 60 at a predetermined flow amount. For example, the injector 40 includes an opening-closing valve that can regulate the flow amount and pressure of the fuel gas from a primary side (the tank 30) to a secondary side (the ejector 60), by driving a valve body by an electromagnetic drive force or the like with a predetermined drive period such that the valve body gets away from a valve seat.

In the injector 40, based on a control signal from the control device 80, the opening and closing of the opening-closing valve is controlled by a pulse control, depending on an output amount (a current amount or an output amount) that is required of the fuel cell 10, and a predetermined amount of fuel gas is intermittently injected toward the ejector 60.

The injector 40 has a characteristic critical pressure ratio at which the switching between unchoked flow (subsonic flow) and choked flow (sonic flow) is performed. From the standpoint of the accuracy of the flow amount control for the fuel gas, for example, the fuel cell system 100 may cause the injector 40 to operate mainly in a choked flow region of the injector 40.

For example, the LSV 50 arbitrarily controls the flow amount of the fuel gas in proportion to the opening degree of a solenoid valve, by controlling the opening degree from the primary side (the tank 30) to the secondary side (the ejector 60) to an arbitrary opening degree between the maximal opening degree and an opening degree for valve closing, using a plunger that is driven by a solenoid. The structure of the LSV 50 is not particularly limited, and a known structure for the LSV can be employed.

The LSV 50 is disposed in parallel with the injector 40. The supply flow passage 32 for the fuel gas is configured such that the supply destination of the fuel gas can be switched between the injector 40 and the LSV 50 based on a control signal from the control device 80.

The LSV 50 also has a characteristic critical pressure ratio, and the switching between unchoked flow and choked flow is performed at the critical pressure ratio. From the standpoint of the accuracy of the flow amount control for the fuel gas, the fuel cell system 100 may cause the LSV 50 to operate mainly in a choked flow region in which the pressure ratio is higher than the critical pressure ratio.

In the LSV 50, based on a control signal from the control device 80, plunger operation and solenoid valve operation are regulated by a linear control, depending on an output amount (a current amount) that is required of the fuel cell 10, and a predetermined amount of fuel gas is injected toward the ejector 60.

The ejector 60 is provided between injection devices of the injector 40 and the LSV 50 and the fuel cell 10 on the supply flow passage 32 for the fuel gas. The ejector 60 is connected with a circulation flow passage 70 for the off-gas that is introduced from an inlet port 10a for the fuel gas into the fuel cell 10 and is exhausted from an outlet port 10b for the fuel gas. The circulation flow passage 70 is configured such that the off-gas flows back to the inlet port 10a for the fuel gas. As necessary, the circulation flow passage 70 may include a circulation pump that is driven by a motor or the like and that increases the gas pressure of the off-gas to a moderate gas pressure by compression to cause the off-gas to flow back to the supply flow passage 32. From the circulation flow passage 70, an exhaust flow passage 74 for exhausting the off-gas to the exterior of the fuel cell system 100 through a gas-liquid separator 72 branches. An unillustrated exhaust valve is installed in the exhaust flow passage 74, and the off-gas is exhausted by the opening and closing of the exhaust valve.

The ejector 60 suctions the off-gas from the circulation flow passage 70, by the fuel gas that flows into the ejector 60 through the injector 40 or the LSV 50, and introduces the off-gas into the fuel cell 10 together with the fuel gas. The suction amount (circulation flow amount) of the off-gas by the ejector 60 increases as the supply amount and supply pressure of the fuel gas from the injector 40 or the LSV 50 are higher.

A pressure sensor 62 that detects the pressure of mixed gas of the fuel gas and the off-gas that are injected from the ejector 60 and are introduced into the fuel cell 10 is provided downstream of the ejector 60 between the fuel gas inlet port 10a of the fuel cell 10 and the ejector 60. A pressure value detected by the pressure sensor 62 is sent to the control device 80.

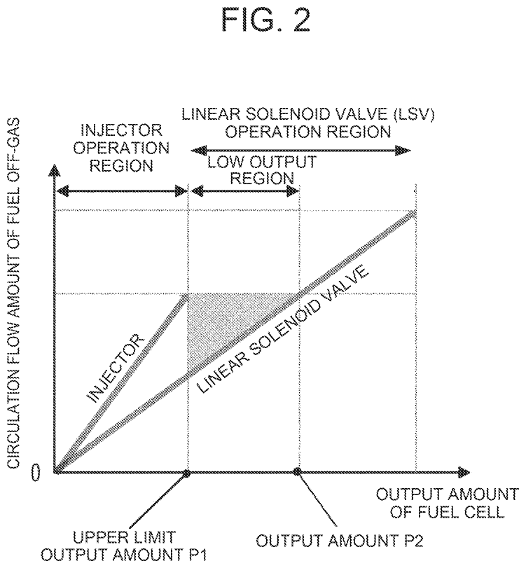

Next, the operations of the injector and the LSV will be described. FIG. 2 shows the relation between operation ranges of the injector 40 and the LSV 50 and the off- gas amount that is suctioned and circulated by the ejector 60 in the output amount range of the fuel cell 10. As shown in FIG. 2, the injector 40 operates in a region (injector operation region) in which the output amount of the fuel cell 10 is smaller in the range of the output amount of the fuel cell 10. Further, the LSV 50 operates in a region (LSV operation region) in which the output amount is larger. In other words, the injector 40 operates in a range in which the flow amount of the fuel gas is smaller in the flow amount range of the fuel gas that corresponds to the output amount range of the fuel cell 10, and the LSV 50 operates in a range in which the flow amount is larger in the output amount range of the fuel cell 10. For example, the injector 40 may operates mainly in a flow amount region corresponding to the choked flow region of the injector 40, and the LSV 50 may operate mainly in the flow amount region corresponding to the choked flow region of the LSV 50 that is exceeding the region in which the injector 40 operates. Thereby, it is possible to perform a high-accuracy flow amount control in a wide range of the output amount of the fuel cell 10, in other words, in a wide range of the flow amount of the fuel gas.

For example, an upper limit output amount P1 of the fuel cell 10 that allows the injector 40 to operate can be set to an output amount corresponding to the maximal fuel gas that allows the injector 40 to stably realize the choked flow.

The injector operation region that is the range of the output amount of the fuel cell 10 in which the injector 40 operates is an example of the first output region in the present specification. Further, the upper limit output amount P1 of the fuel cell 10 that allows the injector 40 to operate is an example of the first output amount threshold in the present specification. Further, the LSV operation region that is exceeding the upper limit output amount P1 and that is the range of the output amount of the fuel cell 10 in which the LSV 50 operates is an example of the second output region in the present specification.

As shown in FIG. 2, when the injector 40 and the LSV 50 are used in the output range of the fuel cell 10 in a switching manner, the circulation flow amount of the off-gas is smaller than the suction amount (circulation flow amount) of the off-gas by the injector 40 before the switching, in a low output region of the operation region of LSV 50 in which the output amount of the fuel cell 10 is larger than the upper limit output amount P1 and the LSV 50 is used. This is because the opening degree of the solenoid valve that is planned for the output amount of the fuel cell 10 is small in the LSV 50 that continuously injects the fuel gas, and thereby the ejection pressure of the fuel gas is lower than that of the injector 40, so that the suction force for the off-gas in the ejector 60 decreases. Thereafter, when the output amount of the fuel cell 10 increases, the planned opening degree of the solenoid valve that is specified for the output amount also increases, and the circulation flow amount of the off-gas gradually increases, and becomes equivalent to the circulation flow amount of the off-gas when the injector 40 operates (when the opening-closing valve is open), at the output amount P2. Thereafter, the off-gas circulation amount increases depending on the planned opening degree of the solenoid valve.

In this way, in the low output region in which the output amount of the fuel cell 10 is larger than the upper limit output amount P1 and is equal to or smaller than the output amount P2, the off-gas amount that is circulated and introduced in to the fuel cell 10 is small, and therefore a hydrogen amount that is included in a smallest hydrogen amount (minimal hydrogen amount: hydrogen concentration or hydrogen stoichiometric ratio) necessary for the operation of the fuel cell 10 and that is derived from the hydrogen in the off-gas is insufficient.

Therefore, in the low output region of the LSV operation region, the LSV 50 operates so as to open at an opening degree larger than the opening degree of the solenoid valve that is planned about the LSV 50 for the output amount of the fuel cell 10. By opening the valve at the opening degree larger than the planned opening degree, a larger amount of fuel gas than a planned amount is supplied to the ejector 60, and the hydrogen concentration in the gas that is supplied to the fuel cell 10 is increased. At the same time, by increasing the supply amount of the fuel gas to the ejector 60, a larger amount of off-gas than a planned amount is suctioned in the ejector 60, and is circulated to the fuel cell 10. As a result, even in the low output region, it is possible to restrain the decrease in the hydrogen stoichiometric ratio in the fuel cell 10. For example, it is possible to secure at least the minimal hydrogen concentration necessary for the operation of the fuel cell 10, and it is possible to restrain the deterioration of an electrode or the like due to the insufficient hydrogen in the fuel cell 10.

The output amount P2 at which the circulation flow amount at the valve opening degree that is planned for the output amount of the fuel cell 10 in the low output region of the LSV 50 becomes equivalent to the circulation flow amount when the injector 40 operates is an example of the second output amount threshold in the present specification. Further, the circulation flow amount of the off-gas when the injector 40 operates is an example of the target flow amount in the present specification. Further, the low output region in which the output amount is larger than the upper limit output amount P1 and is equal to or smaller than the output amount P2 is an example of the third output region in the present specification. The minimal hydrogen amount necessary for the operation of the fuel cell 10 is an example of the hydrogen amount threshold in the present specification.

The control device 80 is configured as a computer that includes a processor and a memory such as a RAM and a ROM. Operation controls of parts of the fuel cell system 100 are executed in accordance with programs stored in the ROM and the like.

Further, the control device 80 is connected with each of the regulator 34, the injector 40, the linear solenoid valve 50, and the ejector 60 that are positioned downstream of the tank 30, and controls operations of them, based on detection values from various sensors in the fuel cell system 100. Further, the control device 80 is connected with an input unit of an electric power supply object apparatus (external apparatus) with which the fuel cell system 100 is connected, and acquires the output amount that is required of the fuel cell 10, and the like, from the input unit.

The control device 80 decides the circulation flow amount of the off-gas that is suctioned by the ejector 60 and is circulated to the fuel cell 10, from the structure of the ejector 60, other parameters that are previously acquired, valve opening degrees of the LSV 50 and the like, the supply amount of the fuel gas, the hydrogen stoichiometric ratio detected in the fuel cell 10, and the like.

When the control device 80 executes a flow amount control program for the fuel gas by which the flow amount of the fuel gas is controlled, the control device 80 outputs control signals to the injector 40 and the LSV 50, and controls operations of the injector 40 and the LSV 50.

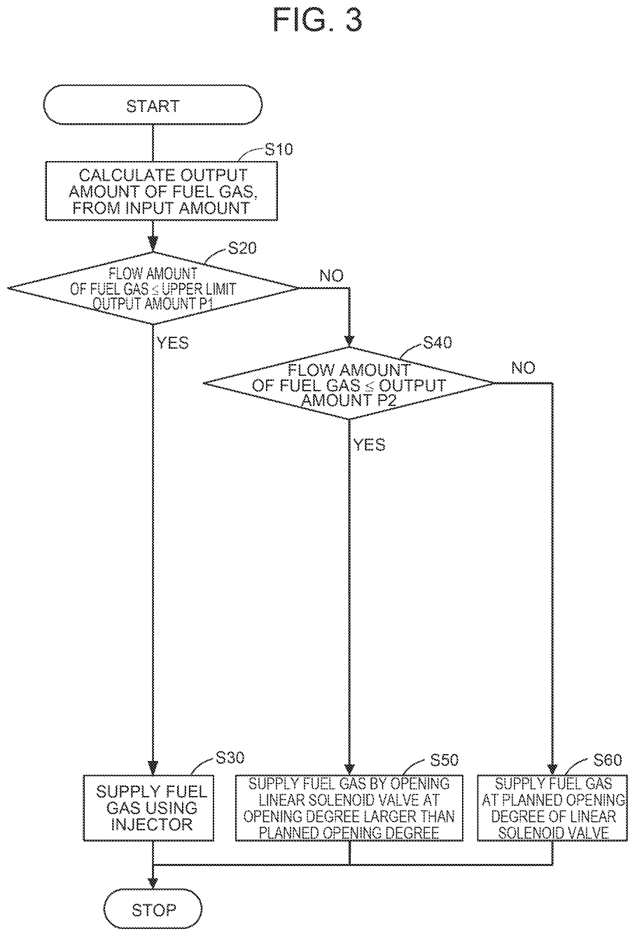

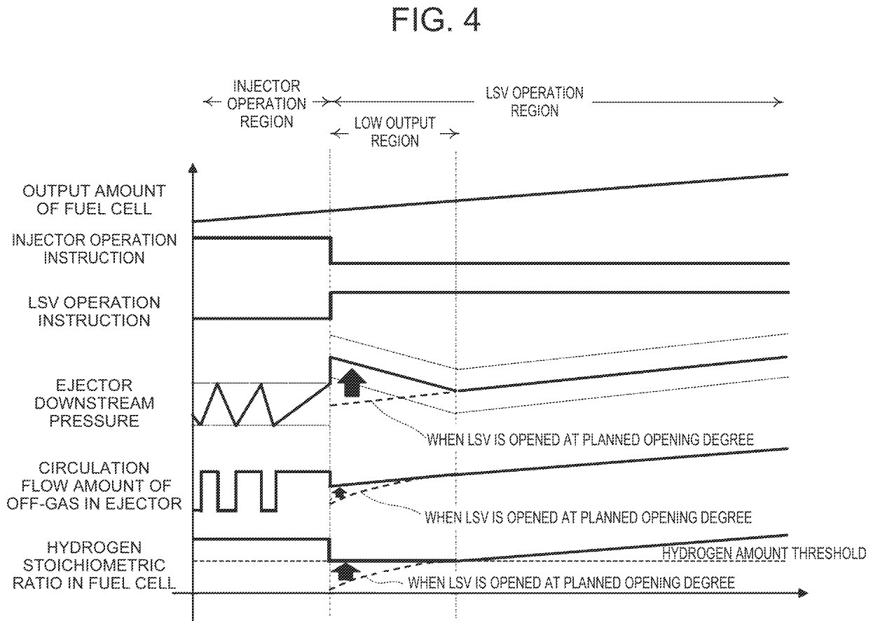

Next, a process and operation for controlling the flow amounts of the fuel gas and off-gas in the fuel cell system 100 will be described with reference to FIG. 3 and FIG. 4. When the processor of the control device 80 detects an input relevant to the output amount of the fuel cell 10 from the input unit of the external apparatus, the processor of the control device 80 repeatedly executes a process specified in the flow amount control program for the fuel gas. FIG. 3 shows an exemplary flow of this process, and FIG. 4 shows, as a time chart, operations of parts of the fuel cell system 100 in this process. In FIG. 4, the operations in this process are shown by solid lines, and operations in the related art are shown by dotted lines.

First, the processor calculates the output amount that is required of the fuel cell 10, based on the input amount acquired from the input unit of the external apparatus (step S10). For example, in the case where the external apparatus is a vehicle, the output amount is calculated based on the accelerator operation amount by a driver, the situation of the vehicle, and the like.

Furthermore, the processor determines whether the output amount is in the output region in which the injector 40 should be used, that is, whether the output amount is equal to or smaller than the upper limit output amount P1 (step S20). When the output amount is in the output region in which the injector 40 should be used (when the output amount is equal to or smaller than the upper limit output amount P1), the processor supplies the fuel gas to the fuel cell 10 by performing the opening-closing control of the valve body of the injector 40 that is planned such that the fuel gas flow amount corresponding to the output amount that is input is supplied to the fuel cell 10 (step S30), and ends this processing.

When the fuel gas is supplied to the fuel cell 10 using the injector 40, as shown in FIG. 4, in the injector operation region, the pressure of the downstream side of the ejector 60 changes depending on the intermittent ejection of the fuel gas from the injector 40. Further, the circulation flow amount of the off-gas in the ejector 60 changes depending on the intermittent ejection of the fuel gas from the injector 40. Further, the hydrogen stoichiometric ratio is maintained by the fuel gas and the off-gas, so as to sufficiently exceed the minimal hydrogen amount necessary for the operation of the fuel cell 10.

On the other hand, when the processor determines that the output amount is in the output region in which the output amount is larger than the upper limit output amount P1 and the LSV 50 should be used, the processor further determines whether the output amount is in the low output region in which the output amount is equal to or smaller than the output amount P2 or in an output region exceeding the low output region (step S40). When the processor determines that the output amount is in the low output region, the processor supplies the fuel gas to the fuel cell 10 by performing the operation such that the opening degree of the LSV 50 is larger than the planned opening degree that is previously specified for the output amount, for satisfying the output amount and satisfying the minimal hydrogen amount (step S50), and ends this processing.

The processor can decide the opening degree of the LSV 50 that satisfies the output amount and the hydrogen amount threshold, based on the required output amount, the relation between the opening degree of the LSV and the flow amount of the fuel gas, the flow amount and pressure of the fuel gas, the circulation flow amount of the off-gas, the hydrogen amount in the fuel cell 10, the hydrogen amount in the off-gas, and the like. The circulation flow amount of the off-gas can be unambiguously calculated from operation conditions such as the flow amount of the fuel gas and parameters of the ejector 60 itself.

By this control of the opening degree of the solenoid valve of the LSV 50 in the low output region of the LSV 50, the flow amount of the fuel gas becomes larger than the flow amount that is planned. As shown in FIG. 4, in the related art in which the LSV 50 is opened at the planned opening degree, the pressure at the outlet port of the ejector 60 is significantly lower than the pressure at the outlet port in the injector operation region. On the other hand, according to the control in the low output region of the LSV 50, for example, by the increased fuel gas flow amount, the pressure at the outlet port of the ejector 60 is increased to a level higher than the pressure at the outlet port by the injector 40. Further, in the related art, the circulation flow amount of the off-gas in the ejector 60 is significantly smaller than the circulation flow amount in the operation region of the injector 40. However, according to this control, the decrease in the circulation flow amount of the off-gas can be compensated by the increased fuel gas flow amount. Furthermore, the related art cannot satisfy the hydrogen amount threshold necessary for the operation of the fuel cell 10 in the operation region of the injector 40. However, according to this control, the minimal hydrogen amount necessary for the operation of the fuel cell 10 is satisfied by the increased fuel gas flow amount and the increased circulation flow amount of the off-gas.

On the other hand, when the processor determines that the output amount is in the region exceeding the low output region, the processor supplies the fuel gas to the fuel cell 10 by causing the LSV 50 to operate at the planned opening degree that is previously set for the output amount (step S60), and ends this processing.

As described above, in the fuel cell system 100, the injector 40 and the LSV 50 are selectively used depending on the output amount that is required of the fuel cell 10, and thereby it is possible to perform a high-accuracy flow amount control depending on the characteristics of the respective injection devices, in a wide output range of the fuel cell 10. Further, in the low output region of the operation region of the LSV 50, the LSV 50 is opened at an opening degree larger than the planned opening degree, and thereby the flow amount of the fuel gas is increased. Thereby, it is possible to increase the circulation flow amount of the off-gas in the ejector 60. By the increase in the flow amount of the fuel gas and the increase in the circulation flow amount of the off-gas, it is possible to secure the minimal hydrogen amount necessary for the operation of the fuel cell 10. Thereby, it is possible to restrain the deterioration of the fuel cell 10. Further, it is possible to secure a total circulation flow amount (the supply amount of the fuel gas and the circulation flow amount of the off-gas) in the fuel cell 10, and to avoid inconvenience due to an insufficient total circulation flow amount.

The present specification includes the following configurations.

[1] A fuel cell system comprising a circulation system for fuel gas in a fuel cell, wherein:
the circulation system includes
   an injector for the fuel gas,
   a linear solenoid valve for the fuel gas, the linear solenoid valve being disposed in parallel with the injector, and
   an ejector that introduces fuel off-gas exhausted from the fuel cell, into the fuel cell, together with the fuel gas from the injector and the linear solenoid valve;
the injector operates when an output amount of the fuel cell is in a first output region, an upper limit of the first output region being a first output amount threshold;
the linear solenoid valve operates when the output amount of the fuel cell is in a second output region in which the output amount of the fuel cell is larger than the first output amount threshold; and
when the output amount of the fuel cell is in a third output region that is included in the second output region and in which the output amount of the fuel cell is larger than the first output amount threshold and is equal to or smaller than a second output amount threshold, the linear solenoid valve opens at such a degree that the fuel gas and the fuel off-gas that are necessary to secure a hydrogen amount threshold are capable of being introduced from the ejector into the fuel cell, the hydrogen amount threshold being a smallest hydrogen amount necessary for operation of the fuel cell.

[2] The system according to [1], wherein when the output amount of the fuel cell is in the third output region, the linear solenoid valve opens at an opening degree larger than a planned opening degree that is previously specified for the output amount of the fuel cell.

[3] The system according to [2], wherein when the output amount of the fuel cell is in the third output region, the linear solenoid valve opens such that the opening degree is larger than the planned opening degree as the output amount of the fuel cell is smaller.

[4] The system according to any one of [1] to [3], wherein the second output amount threshold is such an output amount that a circulation flow amount of the fuel off-gas reaches a target flow amount at the planned opening degree for the output amount of the fuel cell.

[5] The system according to any one of [2] to [4], wherein after the output amount of the fuel cell exceeds the third output region, the linear solenoid valve opens at the planned opening degree for the output amount of the fuel cell.

Specific examples of the technology disclosed in the present specification have been described above in detail. They are just examples, and do not limit the scope of the claims. The technology described in the claims includes various modifications and alterations of the above-described specific examples that are relevant to, for example, the control method for the fuel cell. The technical elements described in the present specification or the drawings exert technical utility independently or by various combinations, and are not limited to the combinations described in the claims at the time of the filing. The technology exemplified in the present specification or the drawings can concurrently achieve a plurality of purposes, and has technical utility simply by achieving one purpose of them.

What is claimed is:

1. A fuel cell system comprising a circulation system for fuel gas in a fuel cell, wherein:
the circulation system includes
an injector for the fuel gas,
a linear solenoid valve for the fuel gas, the linear solenoid valve being disposed in parallel with the injector, and
an ejector that introduces fuel off-gas exhausted from the fuel cell, into the fuel cell, together with the fuel gas from the injector and the linear solenoid valve;
the injector operates when an output amount of the fuel cell is in a first output region, an upper limit of the first output region being a first output amount threshold;
the linear solenoid valve operates when the output amount of the fuel cell is in a second output region in which the output amount of the fuel cell is larger than the first output amount threshold; and
when the output amount of the fuel cell is in a third output region that is included in the second output region and in which the output amount of the fuel cell is larger than the first output amount threshold and is equal to or smaller than a second output amount threshold, the linear solenoid valve opens at such a degree that the fuel gas and the fuel off-gas that are necessary to secure a hydrogen amount threshold are capable of being introduced from the ejector into the fuel cell, the hydrogen amount threshold being a smallest hydrogen amount necessary for operation of the fuel cell.

2. The system according to claim 1, wherein when the output amount of the fuel cell is in the third output region, the linear solenoid valve opens at an opening degree larger than a planned opening degree that is previously specified for the output amount of the fuel cell.

3. The system according to claim 2, wherein when the output amount of the fuel cell is in the third output region, the linear solenoid valve opens such that the opening degree is larger than the planned opening degree as the output amount of the fuel cell is smaller.

4. The system according to claim 3, wherein the second output amount threshold is such an output amount that a circulation flow amount of the fuel off-gas reaches a target flow amount at the planned opening degree for the output amount of the fuel cell.

5. The system according to claim 4, wherein after the output amount of the fuel cell exceeds the third output region, the linear solenoid valve opens at the planned opening degree for the output amount of the fuel cell.
